(19) United States
(12) Patent Application Publication
(10) Pub. No.: US 2022/0215327 A1
(43) Pub. Date: Jul. 7, 2022

(54) WORK ANALYSIS DEVICE, WORK ANALYSIS METHOD AND COMPUTER-READABLE MEDIUM

(71) Applicant: OMRON Corporation, Kyoto-shi, KYOTO (JP)

(72) Inventors: Kazunori KITAZUMI, Kyoto-shi, KYOTO (JP); Kiyoaki TANAKA, Kyoto-shi, KYOTO (JP)

(21) Appl. No.: 17/607,166

(22) PCT Filed: Feb. 19, 2020
(86) PCT No.: PCT/JP2020/006530

§ 371 Date: Oct. 28, 2021

(30) Foreign Application Priority Data
May 9, 2019 (JP) 2019-088930

(51) Int. Cl. G06Q 10/06; G06V 20/52; G06V 40/10

(52) U.S. Cl. CPC G06Q 10/063114; G06Q 10/0633; G06V 2201/07; G06V 40/10; G06V 20/52

(57) ABSTRACT

A work analysis device configured to analyze a work step that includes a plurality of processes, the work analysis device including: a reception unit configured to receive a captured image of a work area; a detector unit configured to parse the captured image and detecting the position and orientation of a worker working in the work area; a determination unit configured to determine the process being performed by the worker on the basis of the position and orientation of the worker; and a generation unit configured to measure a work time for each of the processes and generating a time chart representing the processes in the work step performed by the worker.

### FIELD

The present invention relates to a work analysis device, a work analysis method and program.

### BACKGROUND

Although traditional line manufacturing is suited to large-volume production of a single finished product, low-volume production of a wide variety of finished products remains a challenge in some cases. Consequently, cellular manufacturing, which is suited to high-variety low-volume production, is becoming increasingly common. Cellular manufacturing is a method of production in which one or a few workers complete the assembly of a finished product on a line, which is referred to as a cell, whereat the parts and tools are laid out in a U-shape, or the like.

Techniques have been proposed for extracting and remedying issues during the manufacturing steps of cellular manufacturing. One technique involves tracking a person via a captured image and analyzing the work time and travel distance of a worker in each process, while another technique involves automatically recording the worker's line of flow (see for example, Patent Documents 1, 2).

### RELATED ART DOCUMENTS

### Patent Documents

[Patent Document 1] Japanese Patent Publication No. 2018-073176
[Patent Document 2] Japanese Patent Publication No. 2018-010366

### SUMMARY

### Technical Problem

However, for instance, the U-shaped cell line is such that in some cases the orientation of the worker in a travel area enclosed by a cell cannot be determined, and the cell (workstation) at which the worker is performing a work step cannot be accurately captured even on analyzing the worker's line of flow. In this case, it is difficult to accurately measure a work time for the process performed in each cell, and it tends to be difficult to detect the process missed by the worker or assess whether the cell layout is appropriate.

In one aspect, the present invention aims to address the above-mentioned disadvantages by providing techniques for more accurately capturing the processes in a work step performed by a worker in cellular manufacturing.

### Solution to Problem

To address the above-described disadvantages, one aspect of the present invention is configured as follows.

A first aspect of the present invention provides a work analysis device configured to analyze a work step that includes a plurality of processes, the work analysis device characterized by including: a reception unit configured to receive a captured image of a work area; a detector unit configured to parse the captured image and detecting the position and orientation of a worker working in the work area; a determination unit configured to determine the process being performed by the worker on the basis of the position and orientation of the worker; and a generation unit configured to measure a work time for each of the processes and generating a time chart representing the processes in the work step carried out by the worker.

A “work area” is an area for performing a series of work steps which includes a plurality of processes. In cellular manufacturing, for example, workstations corresponding to processes are arranged in order of the processes in a work area, and the parts, tools and the like that are used in the respective processes are arranged at each workstation. A “captured image” is, for example, an image of a work area captured by a wide-angle camera or a fish-eye camera. A “time chart” is data that includes the sequence of processes performed by a worker and the work time (also referred to below as a performance time) for each process; the time chart is presented to a user in a display format such as a table, a graph, or the like.

The above work analysis device detects, from a captured image of the work area, a person who is a worker, and can more accurately capture which process the worker is performing on the basis of the position and orientation of the worker. The work analysis device also generates a time chart by measuring the work time of each process, and can more accurately capture the processes in the work steps of the worker.

The work analysis device may further include an imaging device for capturing the captured image and transmitting the captured image to the reception unit. The work analysis device may be integrally configured with a camera (imaging unit), and may be installed at a location that allows capturing an entire work area. A work analysis device thusly configured allows for analysis of the work steps in a work area via a simple device.

The work analysis device may further include a layout analysis unit configured to compare a process included in the time chart and a benchmark process that is a process included in a work step that is a benchmark, and analyze whether or not an improvement is needed with regard to the layout of parts on a workstation in accordance with the benchmark process. A time chart represents information on the processes performed by a worker and a work time. A work step that is a benchmark is a flow of processes (benchmark processes) that are defined in advance. A workstation in a work area is arranged in accordance with the benchmark processes. The work analysis device compares the processes contained in a time chart and the benchmark processes and can thereby analyze with precision whether or not an improvement is needed with regard to the processes that the worker performed.

The layout analysis unit may identify that an improvement is needed with regard to the layout of parts when the sequence of the processes included in the time chart is different from the sequence of the benchmark processes. The layout analysis unit compares the sequence of processes included in a time chart with the sequence of the benchmark processes. The layout analysis unit can analyze whether or not an improvement is needed with regard to a parts layout via a simple assessment.

The layout analysis unit may assign a score to the transition between the processes included in the time chart, and identify that an improvement is needed with regard to the layout of parts when the total of the scores with respect to the transition between the processes is greater than or equal to a predetermined threshold. Even if the sequence of the processes in the time chart and the sequence of the benchmark processes differ, the layout analysis unit can identify that no improvement is needed when the total of the scores with respect to the processes is within a predetermined threshold. Thus, the layout analysis unit is capable of flexibly analyzing whether or not an improvement is needed by assigning a score to the transitions between the processes included in a time chart.

The work analysis device may further include a process analysis unit configured to identify that the worker missed work in a process included in the time chart when the work time of the worker for said process is shorter by a predetermined percentage or more than a standard time predefined for said process. A “standard time” is a standard work time defined for each of the processes that is a benchmark process and can be recorded in an auxiliary storage device of the work analysis device along with information on the benchmark process contained in a work step that is a benchmark. If the work time of a process performed by a worker is shorter than the standard time by a predetermined percentage or more, it is conceivable that the process was not performed. In this case the process analysis unit identifies a process as missed work where the work time was shorter than a predetermined percentage or more. The process analysis unit can present the missed work in a manner suited to the user by more accurately capturing the work steps of the worker.

A second aspect of the present invention provides a work analysis method for analyzing a work step that includes a plurality of processes, the work analysis method characterized by including: a reception step for receiving a captured image of a work area; a detector step for parsing the captured image and detecting the position and orientation of a worker working in the work area; a determination step for determining the process being performed by the worker on the basis of the position and orientation of the worker; and a generation step for measuring a work time for each of the processes being performed and generating a time chart representing the processes in the work step carried out by the worker.

The present invention may be obtained as a program for implementing the relevant method or a non-volatile recording medium upon which such a program is recorded. The above-mentioned means and processing may be freely combined with each other to configure the invention.

### Effects

The present invention provides techniques for more accurately capturing the work content for a worker in cellular manufacturing.

### BRIEF DESCRIPTION OF THE DRAWINGS

FIG. 1 illustrates an example of adopting a work analysis device according to the present invention;

FIG. 2 illustrates an example of the functional configuration of a work analysis device;

FIG. 3 is a flowchart that is an example of work analysis processing;

FIGS. 4A and 4B are diagrams for describing an example of a method for detecting the orientation of a worker;

FIGS. 5A and 5B are diagrams for describing an example of a method for detecting the orientation of a worker;

FIG. 6 is a diagram for describing a method for determination of a process being performed;

FIG. 7 illustrates an example of a time chart presented as a table;

FIG. 8 is an example of a time chart that is plotted as a graph;

FIG. 9 is a diagram for describing an example of layout analysis of parts on a workstation;

FIG. 10 is a diagram for describing an example of a layout analysis of parts by assigning a score; and

FIG. 11 is a diagram for describing an example of a process analysis.

### DETAILED DESCRIPTION

Example Application

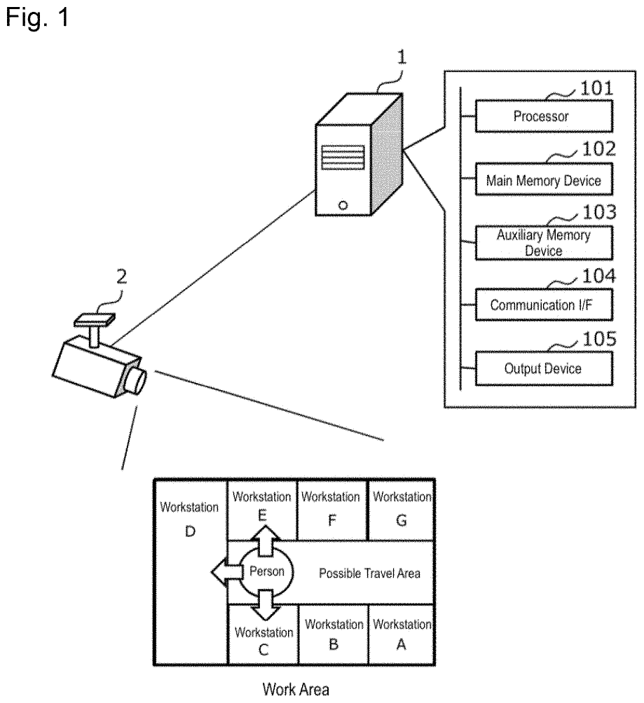

An example application of a work analysis device according to the present invention is described with reference to FIG. 1. A work analysis device 1 receives an image captured by a camera 2 installed above a work area. The work analysis device 1 detects the position and body orientation of a worker from the captured image received, and generates a time chart representing the flow of the work step processes by the worker on the basis of the detection result. The work analysis device 1 can analyze, for example, whether or not the layout of parts at a workstation, and the work step processes or the like by the worker are appropriate by comparing the time chart generated and a time chart of a work step that is a benchmark (benchmark processes).

The work analysis device 1 receives a captured image from a camera 2. The work analysis device 1 detects a person from the captured image and detects the position and orientation of the person. The work analysis device 1 can determine the work details of a worker, that is, the workstation at which the worker is performing a work step among the plurality of workstations in a cell on the basis of the position and orientation of the person.

The work analysis device 1 can generate a time chart representing the flow of work step processes by the worker by measuring the work time [of the worker] at each of the workstations. The work analysis device 1 analyzes whether the workstations are arranged appropriately, or whether the work step processes and the like by the worker are appropriate by comparing the time chart generated with a benchmark time chart prepared in advance. The result of the analysis by the work analysis device 1 is presented to the user. The user can use the analysis result from the work analysis device 1 to change the layout of the workstations, exchange the parts placed at a workstation, revise the benchmark time chart, or the like.

The camera 2 may be installed to overlook a work area, or may be installed at a workstation enclosure oriented toward the travel area of the worker. A plurality of cameras 2 may be installed at each workstation, for example. The camera 2 simply needs to capture a range in which the position and body orientation of the worker in the work area can be recognized; a wide-angle camera or a fish-eye lens camera may be used for the camera 2, for example.

The work analysis device 1 may be configured with the camera 2 (imaging unit) into a single unit. A portion of the processing in the work analysis device 1, such as the process for detecting a person, or the like in a captured image, may also be executed by the camera 2. Moreover, the analysis result from the work analysis device 1 may be transmitted to an external device for presentation to a user.

The above-described work analysis device 1 parses a captured image of a work area and detects the position and orientation of a worker. The work analysis device 1 can more accurately understand at which workstation a worker is performing a work step, that is, the process for which a worker is performing work, by detecting the orientation of the worker. The work analysis device 1 can also generate a time chart more accurately for representing the flow of processes in a work step by the worker. Consequently, the work analysis device 1 can more accurately identify whether the workstations are arranged appropriately, whether the flow of processes by the worker is appropriate, or the like.

### Embodiments

### Device Configuration

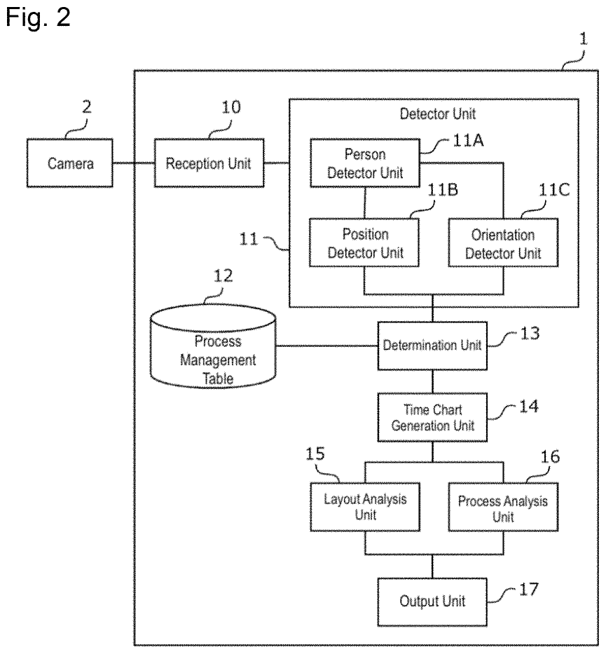

An example of the hardware configuration for the work analysis device 1 according to an embodiment is described with reference to FIG. 1. The work analysis device 1 is provided with a processor 101, a main storage device 102, an auxiliary storage device 103, a communication interface 104, and an output device 105. The processor 101 reads a program stored in the auxiliary storage device 103 into the main storage device 102 and executes the program to thereby implement the functional configurations described with FIG. 2 as functions. The communication interface (I/F) 104 is for carrying out wired and wireless communication. The output device 105 may be a display, speaker, or the like for output.

The work analysis device 1 may be a generic computer such as a personal computer, a server computer, a tablet terminal, or a smartphone, or may be an embedded computer such as an onboard computer. However, the functions of a single device or all the devices may be implemented via dedicated hardware devices such as an ASIC or FPGA. or

The work analysis device 1 can be connected to the camera 2 via wire (USB cable or LAN cable, etc.) or wireless (WiFi, etc.), and receives image data that is captured by the camera 2. The camera 2 is an imaging device having an optical system that contains a lens and an imaging element (an image sensor such as a CCD, CMOS, etc.).

Next, an example with regard to the functional configuration of the work analysis device 1 is described. FIG. 2 illustrates an example of the functional configuration of a work analysis device 1. The work analysis device 1 includes a reception unit 10, a detector unit 11, a process management table 12, a determination unit 13, a time chart generation unit 14, a layout analysis unit 15, a process analysis unit 16, and an output unit 17.

The reception unit 10 includes a function of receiving a captured image from the camera 2. The reception unit 10 transfers the captured image received to the detector unit 11. The reception unit 10 may store the captured image received in the auxiliary storage device 103.

The detector unit 11 includes a function to parse the captured image from the camera 2 to detect a person who is the worker. The detector unit 11 includes a person detector unit 11A, position detector unit 11B, and an orientation detector unit 11C. The person detector unit 11A uses an algorithm for detecting a person, to detect a person from the captured image. The position detector unit 11B detects the position of the person detected; and the position of the person may be taken as the coordinate at the center of a rectangle surrounding the person that was detected. The orientation detector unit 11C detects which workstation the person detected is facing. The orientation detector unit 11C may detect the orientation of the worker, for example, via an AI that uses captured images of persons as the training data, or on the basis of the positional relationship between the head and an arm.

The process management table 12 stores information pertaining to each process. The position information for a workstation may be stored in the process management table 12 in association with, for example, a process corresponding to aforesaid workstation. The position information for a workstation may be computed in advance in accordance with the installation position of the camera 2, and can be stored in the process management table 12. The process management table 12 also stores information pertaining to a work step that is a benchmark. Information on the benchmark processes included in a work step that is a benchmark and a standard work time (standard time) for performing the work for each benchmark process may be stored in the process management table 12.

The determination unit 13 includes a function to determine the process for which a worker is performing work. The determination unit 13 references the process management table 12 and identifies the workstation that the worker is facing on the basis of the position and orientation of the person (worker) detected by the detector unit 11, and determines which process of the work step is being performed by the worker.

The time chart generation unit 14 includes a function to generate a time chart. The time chart generation unit 14 measures the work time within a processes being performed by the worker on the basis of a determination result from the determination unit 13. The work time can be computed from, for instance, the number of frames and the frame rate of a captured image in which a worker remains at a workstation corresponding to aforesaid process. The time chart generation unit 14 generates a time chart on the basis of the work times within each process.

The layout analysis unit 15 includes a function to analyze whether or not the layout of parts on a workstation is appropriate. The layout analysis unit 15 can compare the (flow of) processes included in the time chart generated with the (flow of) benchmark processes to analyze whether or not the layout of part is appropriate.

The process analysis unit 16 includes a function to analyze whether or not a process in the processes included in the time chart (the processes performed by the worker) has missed work. The processes included in the time chart generated by the time chart generation unit 14 can be compared with the benchmark processes included in a work step that is a benchmark to verify whether there is missed work in the time chart.

The output unit 17 includes a function to present the time chart generated by the time chart generation unit 14 and the analysis result from the layout analysis unit 15 and the process analysis unit 16 on a display or the like. The output unit 17 may transmit the time chart generated and the analysis result to an external device so that the external device may display the time chart generated and the analysis result.

Processing for Analyzing a Work Step

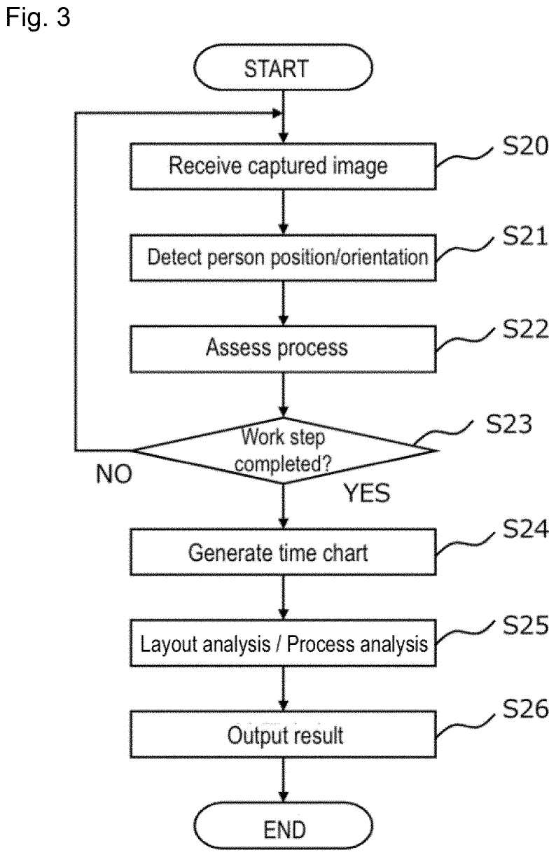

The overall flow of process that analyzes a work step is described according to FIG. 3. FIG. 3 is a flowchart that is an example of work analysis processing. The work analysis processing in FIG. 3 presents an example where the captured images received from the camera 2 are parsed in order while the worker is performing a series of work steps, and a time chart generated after the worker concludes the work step. The time chart is not limited to being generated after the worker concludes the work step; the time chart may be generated in parallel with the receiving and parsing of captured images.

The reception unit 10 receives a captured image from the camera 2 in step S20. The reception unit 10 transfers the captured image received to the detector unit 11.

The detector unit 11 (person detector unit 11A) detects a person from the captured image fed thereto from the reception unit 10 and detects the position and orientation of the person detected. Any kind of algorithm may be used for the person detection. A classifier that combines image features, such as HoG or Haar-like image features with boosting may be used, or a deep-learning based (e.g., R-CNN, Fast R-CNN, YOLO, SSD, etc.) person recognition classifier may be used.

The detector unit 11 (position detector unit 11B) may also detect the position of the person detected in the captured image. The position of the person may be specified as the coordinate at the center of a rectangle surrounding the person that was detected. In addition, the work area may be segmented into a grid and the position of the person may be specified by noting in which the area the person exists.

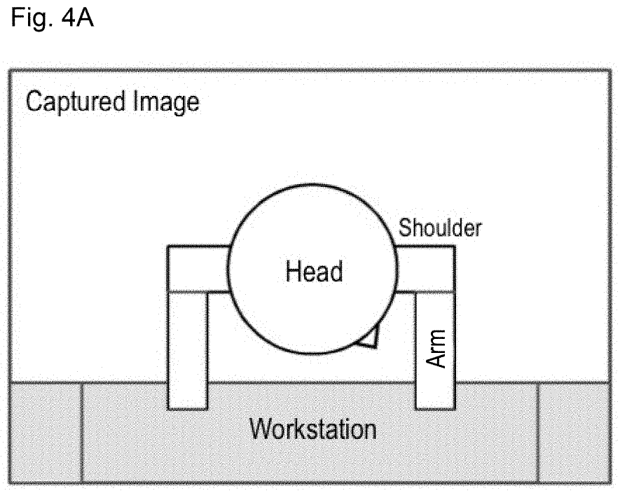

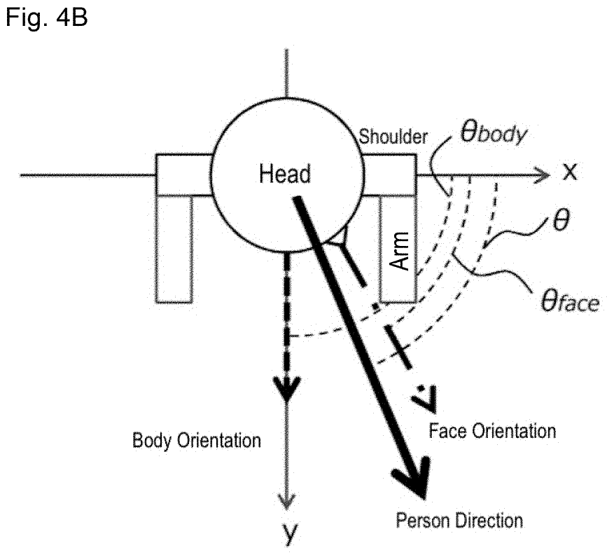

The detector unit 11 (orientation detector unit 11C) may also detect the orientation of the person (worker) detected. Here, a method for detecting the orientation of the worker is described with reference to FIGS. 4A and 4B, and FIGS. 5A and 5B. FIGS. 4A and 4B and FIGS. 5A and 5B are diagrams for describing an example of a method for detecting the orientation of a worker;

FIGS. 4A and 4B depict an example where a single camera 2 is installed to overlook a work area. FIG. 4A is an image of the surroundings of a worker in a captured image taken of the worker from the ceiling. The orientation detector unit 11C can detect the orientation of the worker via an AI such as a CNN, or the like trained on captured images of persons taken from above the head as training data, for instance.

As illustrated in FIG. 4B, the orientation detector unit 11C may detect the orientation of the face θ_{face} and the orientation of the body θ_{body} individually about the x axis via an AI. In this case, the orientation detector unit 11C may multiply the orientation of the face θ_{face} and the orientation of the body θ_{body} with weight coefficients α, β to define the orientation calculated using the below Formula 1 as the orientation of the person.

θ=αθ_{face}+βθ_{body}(0≤θ≤2π,α+β=1) (Formula 1)

where, for example α=β=½, the orientation of the person may be the mean of the orientation of the face θ_{face} and the orientation of the body θ_{body}. Additionally, taking α=⅔, β=⅓, the orientation of the person may be specified (detected) with a priority given to the orientation of the face θ_{face}.

Moreover, the orientation detector unit 11C may detect the orientation of the person on the basis of the mutual positional relationship of the head, an arm, and a hand. For instance, the orientation detector unit 11C may take the orientation of a line segment bisecting the line segments extending from the center of the head to the left and right hands respectively as the orientation of the person.

FIGS. 5A and 5B depict an example where a plurality of cameras 2 is installed along the side of a worker. FIG. 5A is an image of a worker from the side in a captured image taken by cameras 2 installed at the workstation. The orientation detector unit 11C can detect the orientation of the person via an AI such as a CNN or the like trained on captured images of persons taken from the side as training data, for instance.

As illustrated in FIG. 5B, the orientation detector unit 11C may detect the orientation of the face θ_{face} and the orientation of the body θ_{body} individually about the y axis via an AI. In this case, the orientation detector unit 11C may multiply the orientation of the face θ_{face} and the orientation of the body θ_{body} with weight coefficients α, β to define the orientation calculated using the below Formula 2 as the orientation of the person.

θ=αθ_{face}+βθ_{body}(−π/2≤θ≤π/2,α+β=1) (Formula 2)

α and β may be established as appropriate in accordance with the priority of the orientation of the face θ_{face} or the orientation of the body θ_{body}, similar to the case in FIGS. 4A and 4B.

Moreover, the orientation detector unit 11C may detect the orientation of the person on the basis of the mutual positional relationship of the head, body, an arm, and a hand. The orientation detector unit 11C may estimate the orientation of the person on the basis of the angle of an arm relative to the body, for instance.

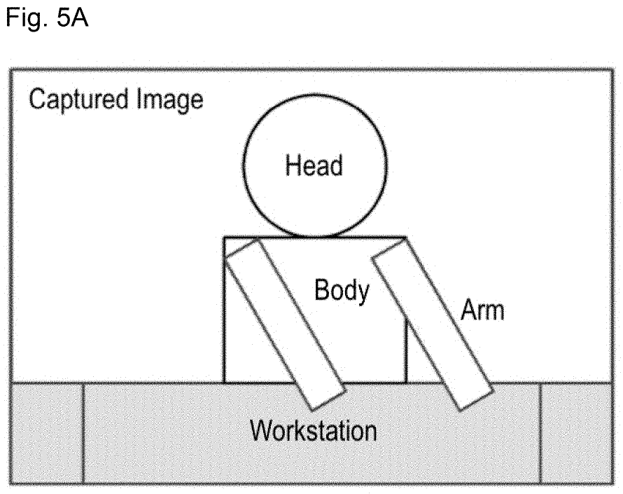

In step S22 in FIG. 3 the determination unit 13 determines the process being performed by the person (worker) detected in step S21. Here, determining the process being performed is described in accordance with FIG. 6. The process being performed is determined on the basis of the position or orientation of the worker.

FIG. 6 is a diagram for describing a method for determining a process being performed; FIG. 6 illustrates a work area for performing a work step that includes processes A through G. Workstations corresponding to the each of the processes A through G (described below as workstations A to G, respectively) are installed in the work area. The area enclosing the workstations A to G is the travel area in which a worker moves while working. The travel area is divided into three travel areas a to c. The travel area a encloses workstation C, workstation D, and workstation E. The travel area b encloses workstation B and workstation F. The travel area c encloses workstation A and workstation G. The position information for workstations A to G and travel areas a to c is stored in advance in the process management table 12.

The determination unit 13 acquires the position information for the travel areas a to c from the process management table 12 and determines in which travel area the worker is present on the basis of the position information of the worker detected in step S21. The determination unit 13 also acquires the position information of the workstations A to G from the process management table 12 and can determine at which workstation work is being performed on the basis of information on the position and orientation of the worker detected in step S21. That is, the determination unit 13 can determine the process for which a worker is performing work. The determination unit 13 can also determine the time for a worker to transition from a process the worker is currently performing to the next process.

The determination unit 13 can count the number of frames of the captured image until the worker moves to the next step to thereby compute the work time for each process. The determination unit 13 may store the work time calculated for each process in the auxiliary storage device 103.

The detector unit 11 (person detector unit 11A) determines whether or not the worker has completed the work step in step S23. The person detector unit 11A can determine that the worker has completed work step, for instance, when the person detector unit 11A does not detect a person in the captured image fed thereto from the reception unit 10. The person detector unit 11A may also determine that the worker has completed the work step when the worker changes orientation from the workstation G where the last process is performed to the workstation A where the first process is performed. The processing continues to step S24 when the series of work steps by the worker is completed (YES, at step S23). The processing returns to step S20 when the worker has not completed the work step (NO, at step S23). The processing from step S20 through step S22 is repeated for each frame of captured image fed in from the reception unit 10 between returning to step S20 and until the work steps are complete.

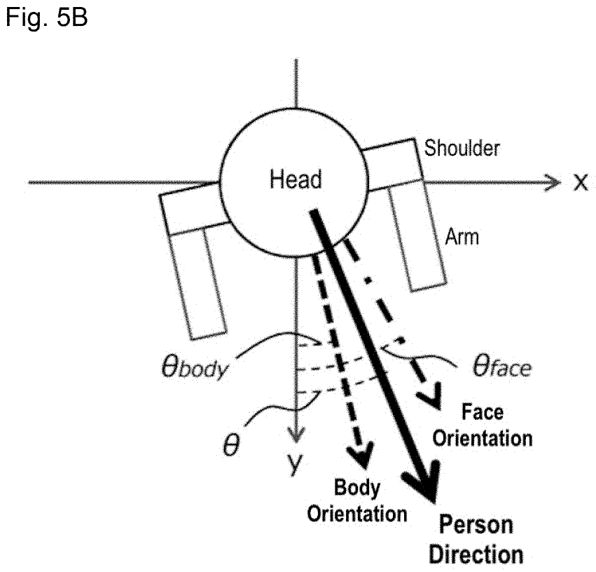

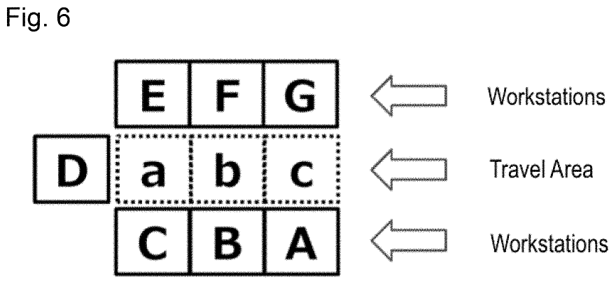

The time chart generation unit 14 generates a time chart in step S24 representing the flow of processes performed by the worker. The time chart generated may be presented on a display or the like, which is the output device 105. Here, an example of the time chart generation unit 14 generating a time chart is described using FIG. 7 and FIG. 8. FIG. 7 and FIG. 8 illustrate an example of a time chart where a worker X and a worker Y perform a work step that includes processes A to G.

FIG. 7 illustrates an example of a time chart presented as a table. The tabular time chart T70 includes the fields: Process, Standard Time, Worker X, and Worker Y. The Process field represents a process included in the work step performed by each worker. The Standard Time field represents a standard time that is conceivable for performing the work for each process. The standard time is defined in advance in accordance with the work content for each process and is stored in a process management table 12. In the example in FIG. 7, the unit for the standard time is minutes. The Worker X field indicates the time the worker X needed to perform the work for each process. The Worker Y field indicates the time the worker Y needed to perform the work for each process. The time in the Worker X field and Worker Y field is indicated in minutes.

The time Worker X requires for either of the processes C, D is two minutes. The standard time for either of the processes C, D is three minutes. The Worker X performs the processes C, D in a time that is shorter than the standard time; the spaces corresponding the processes C, D for the Worker X are enclosed in dotted lines to highlight the space. In contrast, the Worker Y requires five minutes and six minutes for the processes A, D respectively. The standard time for either the processes A, D are two minutes and three minutes respectively. The Worker Y performs the processes A, D in a time that is longer than the standard time; the spaces corresponding the processes A, D for the Worker Y are enclosed in double lines to highlight the space.

The time chart T70 makes it possible to highlight the spaces corresponding to cases where the work time for a process by a worker is shorter or longer than the standard time. Hereby, a user can spot a delay, or the like, in the work of each worker. Note that highlighting is not limited to enclosing a space with a dotted line or a double line; emphasis may be added by changing the background color of the space to be highlighted.

FIG. 8 is an example of a time chart that is graphed (plotted as a graph): The vertical axis is the process and the horizontal axis is the time in the time chart T80 illustrated in FIG. 8. The time chart T80 in FIG. 8 is a graph of the work times depicted in FIG. 7 for the Worker X and the Worker Y. The time chart T80 allows the user to easily spot the work time taken for all work for the workers.

The layout analysis unit 15 analyzes whether or not the layout of parts placed on the workstation is appropriate on the basis of the time chart for the workers in step S25 of FIG. 3. The process analysis unit 16 compares the time chart of the workers to the work that is a benchmark to analyze the work by the workers. The process analysis unit 16 can analyze missing processes by, for instance, determining that a process with short work time was a process that was not performed.

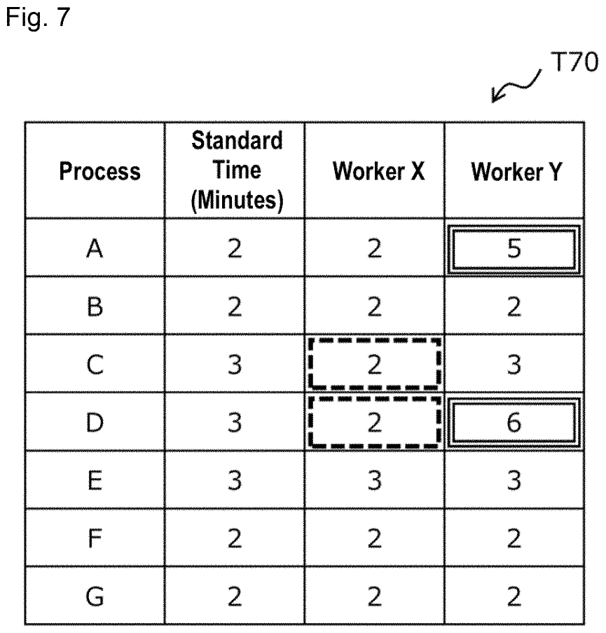

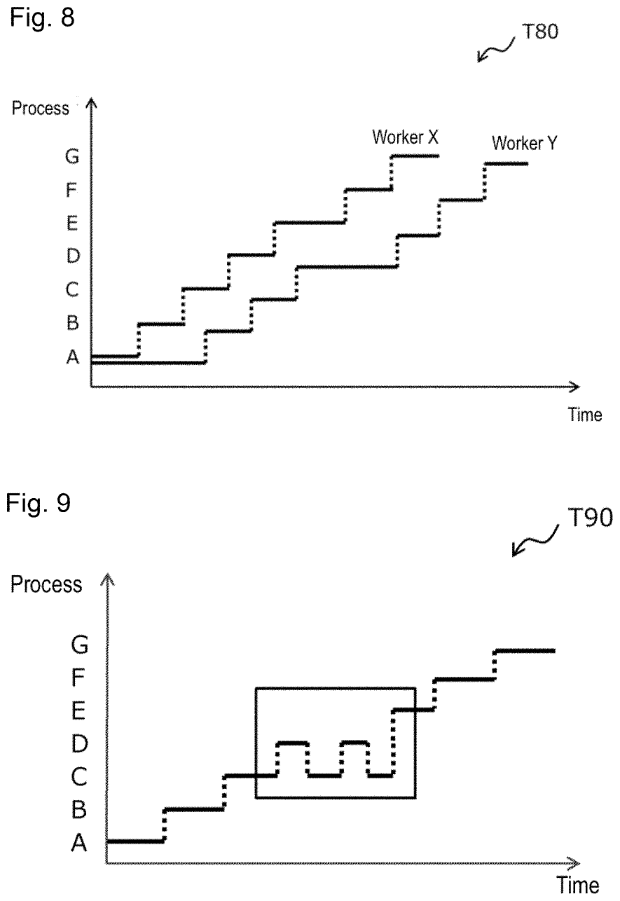

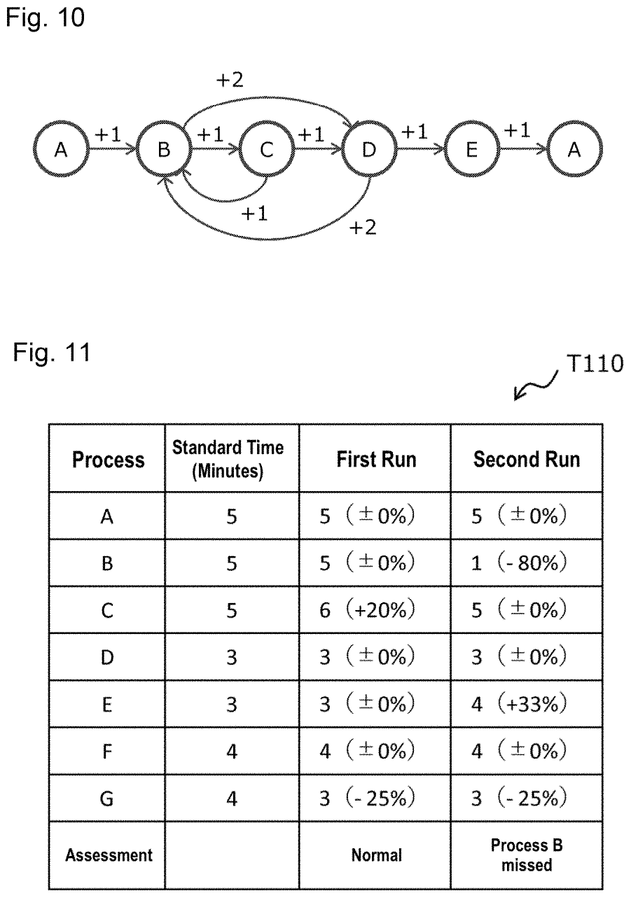

A method of analysis by the layout analysis unit 15 and the process analysis unit 16 is described using FIG. 9 to FIG. 11. FIG. 9 and FIG. 10 are diagrams for describing an example of layout analysis of parts; and FIG. 11 is a diagram for describing an example of a process analysis.

FIG. 9 is a diagram for describing an example of layout analysis of parts on a workstation. In the example in FIG. 9, the layout analysis unit 15 compares the sequence of processes included in the time chart to the sequence of benchmark processes included in a work step that is a benchmark to thereby analyze the layout of the parts placed on the workstations. The vertical axis is the process and the horizontal axis is the time in the time chart T90 illustrated in FIG. 9. Additionally, the benchmark processes in a work step that is a benchmark is assumed to be “Benchmark Processes: A→B→C→D→E→F→G”.

In the time chart T90 illustrated in FIG. 9, the actual processes performed by the worker are “Actual Processes: A→B→C→D→C→D→C→E→F→G”. The processes between the process C to the process E (the portion in the time chart T90 in FIG. 9 surrounded by the rectangle) are different from the benchmark processes. It is conceivable that in this case, the worker moved between the workstation C and the workstation D because the parts used in process C were placed on the workstation D. The layout analysis unit 15 thusly identifies that an improvement is needed with regard to the layout of parts when the sequence of the actual processes by the worker differs from the sequence of the benchmark processes.

FIG. 10 is a diagram for describing an example of layout analysis of parts by assigning a score. FIG. 10 illustrates the points when transitioning between processes. The example is described with the benchmark processes assumed as follows “Benchmark Processes: A→B→C→D→E”. One point is added per move (+1) between processes and the total of the scores for the benchmark processes (referred to below as a “score”) is five points (score=5).

Scores are computed with regard to the three patterns below.
Pattern 1: A→B→C→D→E Score=4
Pattern 2: A→B→C→B→C→D→E Score=6
Pattern 3: A→B→D→B→C→D→E Score=8
   If the score for each pattern is calculated on the basis of the points depicted in FIG. 10, pattern 1 has a score of four points (score=4) because pattern 1 is identical to the benchmark processes. Pattern 2, because the processes “(B)→C→B” are added to the benchmark processes, the score is six points (score=6). Pattern 3, because the processes “(B)→D→B” are added to the benchmark processes, the score is eight points (score=8).

The layout analysis unit 15 identifies whether improvement is needed with regard to the layout of parts in a case where the score thusly calculated for the actual processes is greater than or equal to a predetermined threshold. For example, when the predetermined threshold is taken as seven points, the layout analysis unit 15 determines that the actual processes in pattern 1 and pattern 2 are normal, and determines that actual processes in pattern 3 require improvement.

The predetermined threshold is not limited to the above example of the scores from adding points with respect to the transition between processes depicted in FIG. 10 and is not limited to being used for determining whether or not an improvement is needed. For instance, the scores from adding points with respect to the transitions between processes may be instead be a score in accordance with the distance between the workstations corresponding to a process. Additionally, the predetermined threshold may increase or decrease in accordance with the number of processes that may be included in a series of work steps.

FIG. 11 is a diagram for describing an example of a process analysis. The analysis result T110 illustrated in FIG. 11 includes Process, Standard Time, First Run, and Second Run fields. The Process field represents a process included in the work step performed by each worker. The Standard Time field represents a standard time that is conceivable for performing the work for each process. The standard time is defined in advance in accordance with the work content for each process and is stored in a process management table 12. In the example in FIG. 11, the unit for the standard time is minutes. The First Run field indicates the work time that was needed to perform the processes in a work step in a first run. The Second Run field indicates the work time needed to perform the processes in a work step in a second run. The unit for the First Run field and the Second Run field is minutes. In addition to the work time, the First Run field and the Second Run field also indicate a percentage increase or decrease with respect to the standard time. The process analysis unit 16 can identify that the worker missed work in a process when the work time for aforesaid process is shorter by a predetermined percentage or more, e.g., when the work time of aforesaid process is shorter by 80% or more.

In the example in FIG. 11, the work time of the process B in the second run of the work step is 1 and is 80% shorter compared to the standard time of 5. If the predetermined percentage is established as 80%, the process analysis unit 16 identifies that the process B is the missed work in the second run of the work step. Other than missed work, the process analysis unit 16 can identify that excess work was performed when the work time for a step is longer than a predetermined percentage.

In step S26 of FIG. 3, the output unit 17 presents the time chart generated in step S24 and the result of the analysis in step S25 on a display or the like provided to the work analysis device 1. The output unit 17 may be configured to switch between presenting the time chart and presenting the analysis result in accordance with an instruction from the user. The output unit 17 may also be configured to switch the display format of the time chart (e.g., display formats such as a table, a graph, etc.) in accordance with an instruction from the user.

### Effects of the Embodiment

In the above embodiment the work analysis device 1 can more accurately capture the workstation at which a worker is working, that is, which process a worker is performing on the basis of the position and orientation of the worker.

The work analysis device 1 generates a time chart via a time chart generation unit 14. The layout analysis unit 15 can analyze whether or not an improvement is needed with regard to the layout of parts by comparing the processes in a time chart with benchmark processes in a work step that is a benchmark. The layout analysis unit 15 may also assign a score to the flow of processes indicated in the time chart on the basis of the scores established for the transition between processes. The layout analysis unit 15 is capable of flexibly analyzing whether or not an improvement is needed by assigning a score to the transitions between the processes included in a time chart.

The process analysis unit 16 can more accurately analyze whether or not there is missed work on the basis of the worker's work time for the processes included in the time chart.

Additional Considerations

The above-described embodiment is merely for providing illustration of an example configuration of the present invention. The present invention is not limited to the specific form above described and may be modified in various ways within the scope of the technical ideas therein. For instance, the scoring of points and predetermined threshold illustrated in FIG. 10 are both merely examples for describing the predetermined percentage for analyzing the missing work in FIG. 11. The score from adding points illustrated in FIG. 10 may be configured so that the score from adding points increases or decreases with travel distance between processes.

Additionally, the table illustrated in FIG. 7 and the line graph illustrated in FIG. 8 are provided as examples of display formats in the above-described embodiment for the time chart generated, however, the display format is not limited thereto. The time chart may be presented in a format where the lines of the table in FIG. 7 are replaced. The time chart may be presented according to different kinds of graphs such as a bar graph, pie chart, or the like.

Supplemental Note 1

(1) A work analysis device (1) configured to analyze a work step that includes a plurality of processes, the work analysis device including:

a reception unit (10) for receiving a captured image of a work area;

a detector unit (11) for parsing the captured image and detecting the position and orientation of a worker working in the work area;

a determination unit (13) for determining the process being performed by the worker on the basis of the position and orientation of the worker; and

a generation unit (14) for measuring a work time for each of the processes and generating a time chart representing the processes in the work step carried out by the worker.

(2) A work analysis method for analyzing a work step that includes a plurality of processes, the work analysis method including:

a reception step (S20) for receiving a captured image of a work area;

a detection step (S21) for parsing the captured image and detecting the position and orientation of a worker working in the work area;

a determination step (S22) for determining the process being performed by the worker on the basis of the position and orientation of the worker; and

a generation step (S23) for measuring a work time for each of the processes being performed and generating a time chart representing the processes in the work step carried out by the worker.

Reference Numerals

| 1: Work Analysis Device | 101: Processor | 102: Main Memory Device |
|---|---|---|
| 103: Auxiliary Memory Device | 104: Communication I/F | 105: Output Device |
| 10: Reception Unit | 11: Detector Unit | 11A: Person Detector Unit |
| 11B: Position Detector Unit | 11C: Orientation Detector Unit | 12: Process |
| | | Management Table |
| 13: Determination Unit | 14: Time Chart Generation Unit Layout Analysis Unit | |
| 16: Process Analysis Unit | 17: Output Unit | 2: Camera |

1. A work analysis device configured to analyze a work step that includes a plurality of processes, the work analysis device comprising:
a reception unit configured to receive a captured image of a work area;
a detector unit configured to parse the captured image and detecting the position and orientation of a worker working in the work area;
a determination unit configured to determine the process being performed by the worker on the basis of the position and orientation of the worker; and
a generation unit configured to measure a work time for each of the processes and generating a time chart representing the processes in the work step carried out by the worker.

2. The work analysis device according to claim 1, further comprising: an imaging unit configured to capture the captured image and transmit the captured image to the reception unit.

3. The work analysis device according to claim 1, further comprising: a layout analysis unit configured to compare a process included in the time chart and a benchmark process that is a process included in a work step that is a benchmark, and analyze whether or not an improvement is needed with regard to the layout of parts on a workstation in accordance with the benchmark process.

4. The work analysis device according to claim 3, wherein the layout analysis unit identifies that an improvement is needed with regard to the layout of parts when the sequence of the processes included in the time chart is different from the sequence of the benchmark processes.

5. The work analysis device according to claim 3, wherein the layout analysis unit assigns a score to the transition between the processes included in the time chart, and identifies that an improvement is needed with regard to the layout of parts when the total of the scores with respect to the transition between the processes is greater than or equal to a predetermined threshold.

6. The work analysis device according to claim 1, further comprising: a process analysis unit configured to identify that the worker missed work in a process included in the time chart when the work time of the worker for said process is shorter by a predetermined percentage or more than a standard time predefined for said process.

7. A work analysis method for analyzing a work step that includes a plurality of processes, the work analysis method comprising:
a reception step for receiving a captured image of a work area;
a detection step for parsing the captured image and detecting the position and orientation of a worker working in the work area;
a determination step for determining the process being performed by the worker on the basis of the position and orientation of the worker; and
a generation step for measuring a work time for each of the processes being performed and generating a time chart representing the processes in the work step carried out by the worker.

8. A non-transitory computer-readable medium storing a program for executing on a computer each of the steps in the work analysis method according to claim 7.
